(19) United States
(12) Patent Application Publication
(10) Pub. No.: US 2004/0255054 A1
(43) Pub. Date: Dec. 16, 2004

(54) High-speed data transmission device

(76) Inventors: Khein-Seng Pua, Hsinchu Hsien (TW); Chu-Cheng Liang, Hsinchu Hsien (TW)

Correspondence Address: BIRCH STEWART KOLASCH & BIRCH, PO BOX 747, FALLS CHURCH, VA, 22040-0747, US

(21) Appl. No.: 10/457,390

(22) Filed: Jun. 10, 2003

(51) Int. Cl. G06F 3/00

(52) U.S. Cl. 710/5

(57) ABSTRACT

A high-speed data transmission device is provided. The high-speed data transmission device comprises a controller for converting a data complaint with a serial port interface into a data complaint with a parallel port interface, a controller for converting a data complaint with a parallel port interface for transmitting into a Flash RAM like memory storage element. The controller that converts the data complaint with the parallel port interface for transmitting into a Flash RAM like memory storage element is controlled by the controller for converting the data complaint with the serial port interface into the data complaint with the parallel port interface.

### BACKGROUND OF THE INVENTION

1. The Field of the Invention

The present invention relates to a data transmission device, and more particularly relates to a high-speed data transmission device that can operate as a fully compliant single serial port receiving and sending data using the single serial communication protocols and as a re-transmitting device sending and receiving data to an attached peripheral device as a fully complaint parallel port so that the high-speed parallel port interface device can function with high speed regardless of the, limitations of the Flash RAM like memory storage element, thus high-speed storage and/or retrieval of data from one or more than one Flash RAM like memory storage elements through the data transmission device can be effectively promoted and also renders the system suitable for data transmission to a variety of Flash RAM like memory storage element.

2. Description of the Related Art

With the rapid development of data transmission technology via high-speed parallel port and serial port, the high-speed interfaces, such as, USB2.0, IEEE1394, IDE Ultra DMA mode and alike, are available to promote the data transmission speed. However, the data transmission speed of the Flash RAM like memory storage element is limited and cannot be further improved, instead it is way lower compared to the speed of the high-speed parallel port and the serial port. Taking USB2.0 and IEEE1394 as examples, the data transmission speed is about 480 Mbps and 800 Mbps respectively, while the data transmission speed of IDE Ultra DMA mode is about 133 MB/s. The average data transmission speed of the Flash RAM like memory storage element is merely about 5 MB/s due to its physical feature. Therefore it is highly desirable to resolve the above problems of the Flash RAM like memory storage element and to promote the transmission efficiency of the system as a whole and thereby develop new generation electronic products such as portable CD Rom, MP3, PDA, Pocket PC, digital camera and so on.

The conventional memory storage device is connected to the high-speed serial port (such as USB2.0 interface) of computer for data transmission. FIG. 1 illustrates a conventional method for connecting a conventional memory storage device to a personal computer, wherein the USB port A21 of the memory storage device is connected to a high-speed USB port A11 of the personal computer A10 so as to convert data from USB2.0 interface to Flash RAM interface controller A22 and then the data is stored into the Flash RAM A31. Although USB 2.0 is a high-speed serial port, however due to busy status of the Flash RAM A31, the transmission speed is substantially reduced and thus the data storage into the Flash RAM A31 takes considerable amount of time. Therefore transmission efficiency of the high-speed serial port cannot be fully utilized under such condition. Therefore, it is highly desirable to overcome the above defects in order to fully utilize the high-speed transmission feature of the serial port and thereby improve the transmission efficiency.

### SUMMARY OF THE INVENTION

Accordingly, in the view of the foregoing, the present inventor makes a detailed study of related art to evaluate and consider, and uses years of accumulated experience in this field, and through several experiments, to create a new high-speed data transmission device for sending and receiving data from a Flash RAM like memory storage element that is capable of fully utilizing the high-speed transmission feature of the serial port and thereby improve the transmission efficiency.

In accordance with the above objects and other advantages of the present invention, a high-speed data transmission device is provided. The high-speed data transmission device comprises a controller for converting a data complaint with a serial port interface into a data complaint with a parallel port interface, a controller for converting a data complaint with a parallel port interface for transmitting into a Flash RAM like memory storage element. The controller that converts the data complaint with the parallel port interface and transmits into the Flash RAM like memory storage element is controlled by the controller for converting the data complaint with the serial port interface into the data complaint with the parallel port interface. Thus by using the high-speed data transmission device, the transmission problems described above can be effectively resolved so that the Flash RAM storage interface is not in direct complaint with the high-speed serial port interface but the high-speed transmission feature of the serial port can be fully utilized, and therefore the transmission speed can be effectively promoted.

According to one aspect of the present invention, the high-speed data transmission device comprises a converter which can operate as a fully compliant single serial port receiving and sending data using the single serial communication protocols and as a re-transmitting device sending and receiving data to an attached peripheral device as a fully complaint parallel port. The high-speed data transmission device comprises a controller for converting a data complaint with a serial port interface into a data complaint with a parallel port interface for distributing the data transmission, and also to control the controller for converting the data complaint with a parallel port interface for transmitting into a Flash RAM like memory storage element and to store the data into the Flash RAM like memory storage element. Thus the present invention provides an effective high-speed data transmission device for effectively overcoming the problems of transmission speed using the conventional technology described above.

According to another aspect of the present invention, any number of Flash RAM like memory storage element can be included as long as the bandwidth of the parallel port interface is large enough. As it can be understood by those skilled in the art that the data transmission speed can be increased based on the number of Flash RAM like memory storage elements.

### BRIEF DESCRIPTION OF THE DRAWING

For a more complete understanding of the present invention, reference will now be made to the following detailed description of preferred embodiments taken in conjunction with the accompanying drawings, in which:

FIG. 1 illustrates an operation flow chart of data transmission by connecting a conventional memory storage device with a personal computer; and

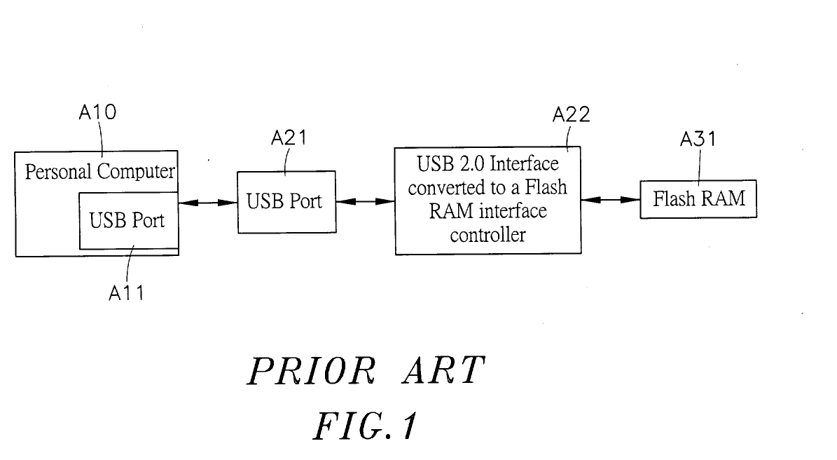

FIG. 2 illustrates an operation flow chart of data transmission by connecting the high-speed data transmission device of the present invention with a personal computer.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

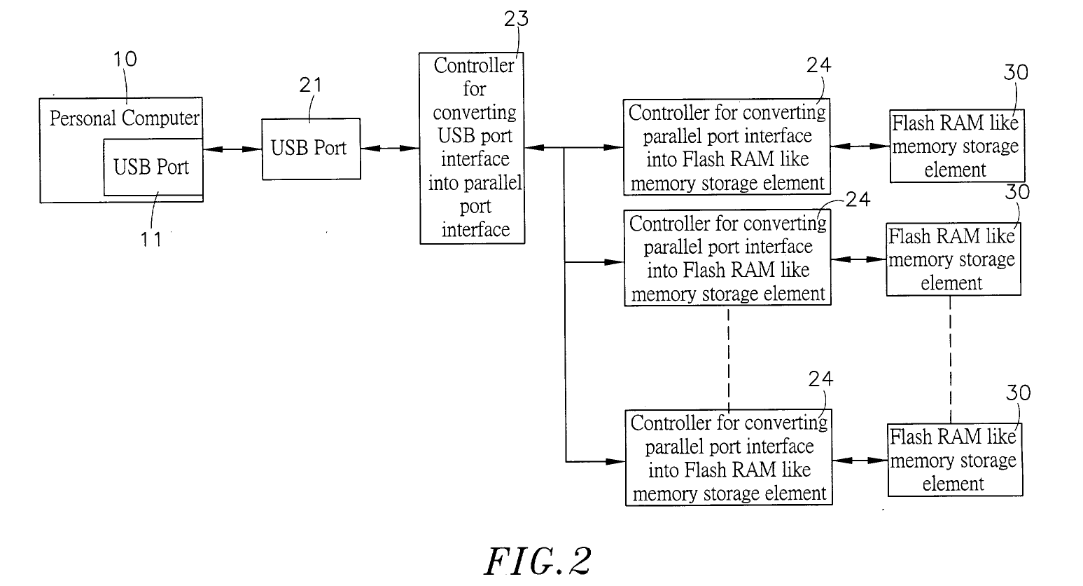

Referring to FIG. 2, the operation process of the high-speed data transmission device that can operate as a fully compliant single serial port receiving and sending data using the single serial communication protocols and as a re-transmitting device sending and receiving data through the parallel port as a fully complaint parallel port is described as follows. The high-speed data transmission device is connected to a personal computer 10, wherein a USB port 21 of the high-speed data transmission device is connected with a high-speed USB port 11 of a personal computer 10. The data complaint with a serial port interface is transmitted from the personal computer 10 through the USB port 21 to a controller 23 of the high-speed data transmission device. The controller 23 converts the data complaint with a serial port interface into a data complaint with a parallel port interface. The data complaint with the parallel port interface is further transmitted from a plurality of parallel controllers 24 of the high-speed data transmission device that convert the data complaint with a parallel port interface for transmitting into a Flash RAM like memory storage element 30, which corresponds to each of the parallel controllers 24. Thus the present invention provides an effective high-speed data transmission device for effectively overcoming the problems of transmission speed of the conventional technology described above. Therefore, the Flash RAM like memory storage element 30 is capable of functioning promptly by using the high-speed serial port interface device of the present invention regardless of the limitation of the physical features of the Flash RAM like memory storage element 30. Since each of the parallel controllers 24 converts the data received from the serial controller 23 into a data that is complaint with a parallel port interface and transmits into a Flash RAM like memory storage element 30, and therefore the data transmission speed can be further increased by increasing the number of the parallel controllers 24.

The above USB port 11 and 21 may be comprised of USB interface, IEEE1394 interface or other high-speed USB interface having an equivalent efficiency.

Furthermore, any of the parallel controllers 24 for converting parallel port interface into the Flash RAM like memory storage element 30 may correspond to one or more than one Flash RAM like memory storage element 30.

Additionally, the Flash RAM like memory storage element 30 may be comprised of a Flash RAM, a Multi-Media Card (MMC), a Memory Stick Card (MS), a Smart Media Card (SM), a Secure Digital Memory Card (SD), a XD-Picture Card (XD) or a Memory Stick PRO (MS PRO).

The Flash RAM like memory storage element 30 may be applied individually or in combination with the high-speed data transmission device having the capability of converting a single serial port into a multi-parallel port Flash RAM like memory storage element 30.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is

1. A high-speed data transmission device that can operate as a fully compliant single serial port receiving and sending data using the single serial communication protocols and as a re-transmitting device sending and receiving data attached peripheral device as a fully complaint parallel port comprising a connecting port for receiving a USB port of a computer for transmitting a data to a controller that converts a data complaint with a serial port interface into a data complaint with a parallel port interface, the data is further transmitted to a plurality of parallel controller that converts the data complaint with parallel port interface for transmitting into a Flash RAM like memory storage element, which corresponds to each of the parallel controller, and finally the data is stored into the Flash RAM like memory storage element.

2. The high-speed data transmission device according to claim 1, wherein said data transmission device further comprises an USB port, a controller for converting a data that is complaint with a serial port interface into a data complaint with a parallel port interface, a controller for converting a data complaint with a parallel port interface for transmitting into a Flash RAM like memory storage element, wherein said USB port may directly connect to a computer or connect between the computer and said serial port interface through a transmission wire, wherein said USB port transmits data from said computer to said controller for converting the data complaint with a serial port interface into the data complaint with a parallel port interface to distribute the data transmission, and further to control the controller for converting the data complaint with parallel port interface for transmitting into the Flash RAM like memory storage element and finally the data is stored into the Flash RAM like memory storage element.

3. The high-speed data transmission device according to claim 1, wherein said USB port is comprised of an USB interface.

4. The high-speed data transmission device according to claim 1, wherein said USB port is comprised of an IEEE1394 interface.

5. The high-speed data transmission device according to claim 1, wherein said controller for converting a data complaint with a serial port interface into a data complaint with a parallel port interface can control one or more than one controller for converting a data complaint with a parallel port interface for transmitting into a Flash RAM like memory storage element.

6. The high-speed data transmission device according to claim 1, wherein said controller for a converting the data complaint with the parallel port interface for transmitting into a Flash RAM like memory storage element corresponds to one or more than one Flash RAM like memory storage elements.

7. The high-speed data transmission device according to claim 6, wherein said Flash RAM like memory storage element is comprised of a Flash RAM.

8. The high-speed data transmission device according to claim 6, wherein said Flash RAM like memory storage element is comprised of a Multi Media Card (MMC).

9. The high-speed data transmission device according to claim 6, wherein said Flash RAM like memory storage element is comprised of a Memory Stick Card (MS).

10. The high-speed data transmission device according to claim 6, wherein said Flash RAM like memory storage element is comprised of a Smart Media Card (SM)

11. The high-speed data transmission device according to claim 6, wherein said Flash RAM like memory storage element is comprised of a Secure Digital Memory Card (SD).

12. The high-speed data transmission device according to claim 6, wherein said Flash RAM like memory storage element is comprised of an XD-Picture Card (XD).

13. The high-speed data transmission device according to claim 6, wherein said Flash RAM like memory storage element is comprised of a Memory Stick PRO (MS PRO).
